(19) United States
(12) Patent Application Publication
(10) Pub. No.: US 2023/0086141 A1
(43) Pub. Date: Mar. 23, 2023

(54) TILING AND OPTIMIZING HIGH-RESOLUTION IMAGES TO IMPROVE NEURAL NETWORK OBJECT DETECTION AND OBJECT DETECTION TRAINING PERFORMANCE

(71) Applicant: ThayerMahan, Inc., Groton, CT (US)

(72) Inventors: William DONG, Petaluma, CA (US); Zane DENMON, Chicago, IL (US); John O'MALIA, Park City, UT (US)

(21) Appl. No.: 17/946,390

(22) Filed: Sep. 16, 2022

Related U.S. Application Data
(60) Provisional application No. 63/246,112, filed on Sep. 20, 2021.

(51) Int. Cl. G06V 10/774; G06V 20/70; G06V 10/10; G06V 10/82; G06V 10/764; G06V 10/26

(52) U.S. Cl. CPC G06V 10/774; G06V 20/70; G06V 10/16; G06V 10/82; G06V 10/764; G06V 10/26

(57) ABSTRACT

Described herein are computer-implemented systems and methods of creating a labeled image. The computer-implemented systems or methods may comprise tiling an input image comprising a native resolution and a native size to generate a set of tiled images and tiling instructions or an encoding thereof used to generate the set of tile images, labeling the set of tiled images to generate a set of labeled tile images, merging the set of labeled tile images using the tiling instructions or encoding thereof to generate a labeled merged image, wherein the labeled merged image comprises the native resolution, the native size, and one or more merged labels.

### CROSS-REFERENCE TO RELATED APPLICATIONS

This application claims the benefit of U.S. Provisional Application No. 63/246,112 filed on Sep. 20, 2021, which application is incorporated herein by reference in its entirety.

### BACKGROUND

This present disclosure relates to object detection and classification in images using artificial intelligence algorithms and processes.

### SUMMARY

Images supplied to conventional neural networks for image processing pipelines and systems, both for neural network training purposes and for detection and classification once the network has been trained, are usually downsampled from their native resolution to a consistent, low-resolution format. For example, when processing the “ImageNet” image dataset, deep learning or neural network models typically work on a pre-processed version of the images downsampled to 256×256 pixels.

Downsampling is a common technique in image processing, as there are exponential computational costs that positively correlate with the resolution size of images. Resizing makes reduces computational cost (and financial cost) sense because it allows for faster training times and requires fewer compute resources. As a result, image resolution and quality may be overlooked when designing neural networks given computational or financial constraints. There is limited and sparse research on applying machine learning methods to high resolution images even though existing research suggests that downsampling may adversely affect the overall accuracy of image processing neural networks, for instance, on object classification tasks.

Directly training large datasets full of high-resolution images (1080p, 2k, 4k, etc.) on a single GPU with current technology is almost impossible within commercial or research time constraints. Training with high-resolution images may pose issues even with larger computational resources where costs may approach millions of dollars. Image tiling has been presented as a technique which researchers may get around these issues of computational cost or financial cost.

Image tiling is a method that splits up high resolution images into smaller “tiles” that can then be fed into an object detection model at its required resolution. After tiling, the object detection models will be able to handle tiled images while the native quality of the original high resolution images are preserved. However, tiling the images also exponentially increases the training time since the number of images the models must process increases based on the number of tiles per image (i.e., 4 images tiled into 4 tiles per image=16 images total).

There are some complications that arise with conventional tiling processes. If objects, object annotations, or object labels within each image are cut off upon tiling, a model will be unable to learn those labels if the tiled annotations are unable to reflect that change. Additionally, if the original high-res images are of all different dimensions, tiling them may lead to training failures due to inconsistent tile sizes or data content.

Even if all of these tiling complications are resolved and the image decomposition into consistent tiles is successful, re-merging the tiles (wherein the tiles may comprise inference information) back into labeled images which can be output from the image processing pipeline is a challenging problem. The number of challenges in merging the processed tiles into a coherent, pixel-true output is directly correlated with challenges encountered during tiling.

The present disclosure, in some aspects, relates to a method for re-integrating and merging previously tiled images and their annotations back to their full native resolutions, coherently labeled by the object detection and classification system, without loss of quality. Some of the methods disclosed herein are image tiling and stitching data processing algorithm for object detection that enables the training and processing of high (native) resolution images at comparable speeds and processing performance to downsampled images. In some domains, the advances described in this disclosure may be essential to the success of training and using a neural network for an object detection and classification task. In one example, in the problem of processing photographs or videos taken with digital cameras, aberrations near the boundaries of objects in an image may contain information about the distance of an object from the point-of-view of a camera. Specific patterns in the aberrations at the boundaries of objects may hold information useful to a model in classification tasks. In another example, in the problem of processing Synthetic Aperture Sonar images from the maritime domain, the pixel scale of images is variable as a function of the distance between the sensor and the object (or the seafloor). Given that the sensor produces image outputs at a constant scale of centimeters-per-pixel, with image size a function of the distance of the sensor from the detected surface, processing the images in their native pixel resolution enables a model to not only use the shape and texture information in the image to determine the object classification, but also its scale as a function of the dimension of the object in pixels. If 10 pixels consistently correlate to 25 cm in the real world, then the model can learn to classify both using the shape and the scale of a target object, which may enable an absolute performance uplift from unsuccessful to successful detections in certain situations.

Whilst this domain-specific exemplar of our method demonstrates notable advantages pertaining to the scale-invariant nature of SAS imagery, the applications of our approach bring advantage to the processing of any kind of high-resolution image.

This present disclosure relates to object detection and classification in images using artificial intelligence algorithms and processes, with particular application to high-resolution images and small objects within those images. The provided methods and system provide performance and accuracy improvements for high-resolution image processing in general, and offer particular benefits to the processing of images where pixel size directly correlates to real-world object scale, such as in images output by Synthetic Aperture Sonar (SAS) systems in the underwater domain.

In one aspect, disclosed herein are computer-implemented systems comprising: at least one a digital processing device comprising at least one processor and instructions executable by the at least one processor to create an image analysis application, the application comprising: a tiling module configured to receive an input image, wherein said input image comprises a native resolution and a native size, and output (i) a set of tile images and (ii) tiling instructions or an encoding thereof used to output said set of tile images, wherein each tile image in said set of tile images comprises a same tile size and said native resolution; a neural network configured to receive said set of tile images from said tiling module and output a set of labeled tile images, wherein each labeled tile image in said set of labeled tile images comprises one or more labels, wherein each label in said one or more labels is a partial label or a complete label; and a merging module configured to receive said set of labeled tile images from said neural network and said tiling instructions or encoding thereof from said tiling module and output a decoded, labeled, merged image, wherein said labeled merged image comprises said native resolution, said native size, and one or more merged labels, wherein each merged label in said one or more merged labels comprises at least one of: (i) a partial label as received from said set of labeled tile images, (ii) a complete label as received from said set of labeled tile images, or (iii) a complete label formed by merging a plurality of partial labels received from said set of labeled tile images. In some embodiments, the system further comprises a training application configured to train said neural network, wherein said training application comprises a training module configured to: tile a set of labeled input images using said tiling module to output a set of labeled tiled input images; remove each image from said set of labeled tiled input images that do not comprise a label; provide said set of labeled tiled input images as training data to said neural network; and train said neural network. In some embodiments, each label in said set of labeled tile images comprises at least one of: a classification label, an image segmentation label, and a label annotation. In further embodiments, each label in said plurality of partial labels shares one or more pixels and a label annotation with at least one other label in said plurality of partial labels. In further embodiments, said classification label is a per-pixel classification label. In further embodiments, said image segmentation label is a bounding box. In still further embodiments, said bounding box is square or rectangular. In some embodiments, said tiling module is additionally configured to add padding to said input image before tiling. In some embodiments, said input image comprises two-dimensions.

In another aspect, disclosed herein are non-transitory computer-readable storage media encoded with instructions executable by one or more processors to create an image analysis application comprising: a tiling module configured to receive an input image, wherein said input image comprises a native resolution and a native size, and output (i) a set of tile images and (ii) tiling instructions or an encoding thereof used to output said set of tile images, wherein each tile image in said set of tile images comprises a same tile size and said native resolution; a neural network configured to receive said set of tile images from said tiling module and output a set of labeled tile images, wherein each labeled tile image in said set of labeled tile images comprises one or more labels, wherein each label in said one or more labels is a partial label or a complete label; and a merging module configured to receive said set of labeled tile images from said neural network and said tiling instructions or encoding thereof from said tiling module and output a labeled merged image, wherein said labeled merged image comprises said native resolution, said native size, and one or more merged labels, wherein each merged label in said one or more merged labels comprises at least one of: (i) a partial label as received from said set of labeled tile images, (ii) a complete label as received from said set of labeled tile images, or (iii) a complete label formed by merging a plurality of partial labels received from said set of labeled tile images. In some embodiments, the non-transitory computer-readable storage media further comprises a training application configured to train said neural network, wherein said training application comprises a training module configured to: tile a set of labeled input images using said tiling module to output a set of labeled tiled input images; remove each image from said set of labeled tiled input images that do not comprise a label; provide said set of labeled tiled input images as training data to said neural network; and train said neural network. In some embodiments, each label in said set of labeled tile images comprises at least one of: a classification label, an image segmentation label, and a label annotation. In further embodiments, each label in said plurality of partial labels shares one or more pixels and a label annotation with at least one other label in said plurality of partial labels. In further embodiments, said classification label is a per-pixel classification label. In further embodiments, said image segmentation label is a bounding box. In still further embodiments, said bounding box is square or rectangular. In some embodiments, said tiling module is additionally configured to add padding to said input image before tiling. In some embodiments, said input image comprises two-dimensions.

In another aspect, disclosed herein are computer-implemented methods of creating a labeled image comprising: tiling an input image comprising a native resolution and a native size to generate (i) a set of tiled images and (ii) tiling instructions or an encoding thereof used to generate said set of tile images, wherein each tile image in said set of tile images comprises a same tile size and said native resolution; labeling, by a neural network on a computer, said set of tiled images to generate a set of labeled tile images, wherein each tile image in said set of labeled tile images comprises one or more labels, wherein each label in said one or more labels is a partial label or a complete label; and merging said set of labeled tile images using said tiling instructions or encoding thereof to generate a labeled merged image, wherein said labeled merged image comprises said native resolution, said native size, and one or more merged labels, wherein each merged label in said one or more merged labels comprises at least one of: (i) a partial label as received from said set of labeled tile images, (ii) a complete label as received from said set of labeled tile images, or (iii) a complete label formed by merging a plurality of partial labels received from said set of labeled tile images. In some embodiments, said neural network is trained with a set of labeled tiled input images as training data, wherein said set of labeled tiled input images is generated by tiling a set of labeled input images, and each image in said set of labeled tiled input images that do not comprise a label is removed from said set of labeled tiled input images. In some embodiments, each label in said set of labeled tile images comprises at least one of: a classification label, an image segmentation label, and a label annotation. In further embodiments, each label in said plurality of partial labels shares one or more pixels and a label annotation with at least one other label in said plurality of partial labels. In further embodiments, said classification label is a per-pixel classification label. In further embodiments, said image segmentation label is a bounding box. In still further embodiments, said bounding box is square or rectangular. In some embodiments, said tiling comprises adding padding to said input image before tiling. In some embodiments, said input image comprises two-dimensions.

### BRIEF DESCRIPTION OF THE DRAWINGS

A better understanding of the features and advantages of the present subject matter will be obtained by reference to the following detailed description that sets forth illustrative embodiments and the accompanying drawings of which:

FIG. 1 shows a non-limiting flowchart illustrating an embodiment of an application; in this case, an embodiment including a model training pipeline and an inference pipeline;

FIG. 2 shows a non-limiting diagram illustrating an embodiment of a tiling method; in this case, an embodiment including resultant tiles without padding and tiles with padding;

FIG. 3 shows a non-limiting exemplary input image and a set of tiled images thereof; in this case, the input image includes a plurality of objects with bounding boxes and the set of tiled images includes objects wherein some of the objects span across tiles;

FIG. 4 shows a non-limiting diagram illustrating a tiling instruction; in this case, an instruction including twelve tiles wherein each tile comprises a tiling sequence number; and

FIG. 5 shows a non-limiting example of a computing device; in this case, a device with one or more processors, memory, storage, and a network interface.

### DETAILED DESCRIPTION

Described herein, in certain embodiments, are computer-implemented systems comprising: at least one a digital processing device comprising at least one processor and instructions executable by the at least one processor to create an image analysis application, the application comprising: a tiling module configured to receive an input image, wherein said input image comprises a native resolution and a native size, and output (i) a set of tile images and (ii) tiling instructions or an encoding thereof used to output said set of tile images, wherein each tile image in said set of tile images comprises a same tile size and said native resolution; a neural network configured to receive said set of tile images from said tiling module and output a set of labeled tile images, wherein each labeled tile image in said set of labeled tile images comprises one or more labels, wherein each label in said one or more labels is a partial label or a complete label; and a merging module configured to receive said set of labeled tile images from said neural network and said tiling instructions or encoding thereof from said tiling module and output a decoded, labeled, merged image, wherein said labeled merged image comprises said native resolution, said native size, and one or more merged labels, wherein each merged label in said one or more merged labels comprises at least one of: (i) a partial label as received from said set of labeled tile images, (ii) a complete label as received from said set of labeled tile images, or (iii) a complete label formed by merging a plurality of partial labels received from said set of labeled tile images.

Also described herein, in certain embodiments, are non-transitory computer-readable storage media encoded with instructions executable by one or more processors to create an image analysis application comprising: a tiling module configured to receive an input image, wherein said input image comprises a native resolution and a native size, and output (i) a set of tile images and (ii) tiling instructions or an encoding thereof used to output said set of tile images, wherein each tile image in said set of tile images comprises a same tile size and said native resolution; a neural network configured to receive said set of tile images from said tiling module and output a set of labeled tile images, wherein each labeled tile image in said set of labeled tile images comprises one or more labels, wherein each label in said one or more labels is a partial label or a complete label; and a merging module configured to receive said set of labeled tile images from said neural network and said tiling instructions or encoding thereof from said tiling module and output a labeled merged image, wherein said labeled merged image comprises said native resolution, said native size, and one or more merged labels, wherein each merged label in said one or more merged labels comprises at least one of: (i) a partial label as received from said set of labeled tile images, (ii) a complete label as received from said set of labeled tile images, or (iii) a complete label formed by merging a plurality of partial labels received from said set of labeled tile images.

Also described herein, in certain embodiments, are computer-implemented methods of creating a labeled image comprising: tiling an input image comprising a native resolution and a native size to generate (i) a set of tiled images and (ii) tiling instructions or an encoding thereof used to generate said set of tile images, wherein each tile image in said set of tile images comprises a same tile size and said native resolution; labeling, by a neural network on a computer, said set of tiled images to generate a set of labeled tile images, wherein each tile image in said set of labeled tile images comprises one or more labels, wherein each label in said one or more labels is a partial label or a complete label; and merging said set of labeled tile images using said tiling instructions or encoding thereof to generate a labeled merged image, wherein said labeled merged image comprises said native resolution, said native size, and one or more merged labels, wherein each merged label in said one or more merged labels comprises at least one of: (i) a partial label as received from said set of labeled tile images, (ii) a complete label as received from said set of labeled tile images, or (iii) a complete label formed by merging a plurality of partial labels received from said set of labeled tile images.

Various embodiments of the tiling module may comprise a set of instructions executable by a computer without departing from the concepts disclosed herein, and the set of instructions may be written in a variety of languages. In some cases, the set of instructions may be written in assembly, Java, JavaScript, Python, C, C#, C++, Octave, MatLab, Mathematica, Objective-C, PHP, SQL, Swift, Tensorflow, PyTorch, Theano, or any combination thereof.

Various embodiments of the merging module may comprise a set of instructions executable by a computer without departing from the concepts disclosed herein, and the set of instructions may be written in a variety of languages. In some cases, the set of instructions may be written in assembly, Java, JavaScript, Python, C, C#, C++, Octave, MatLab, Mathematica, Objective-C, PHP, SQL, Swift, Tensorflow, PyTorch, Theano, or any combination thereof.

Various embodiments of the neural network may comprise a set of instructions executable by a computer without departing from the concepts disclosed herein, and the set of instructions may be written in a variety of languages. In some cases, the set of instructions may be written in assembly, Java, JavaScript, Python, C, C#, C++, Octave, MatLab, Mathematica, Objective-C, PHP, SQL, Swift, Tensorflow, PyTorch, Theano, or any combination thereof.

Various embodiments of a set of instructions may be implemented on one or more processor(s) without departing from the concepts disclosed herein. In some cases, the set of instructions may be implemented on an integrated chip, a random-access memory, a digital computer, an analog computer, or by a calculator.

Various embodiments of an input image may comprise any native size without departing from the concepts disclosed herein. In some cases, the input image may comprise 1-dimension, 2-dimensions, 3-dimensions, 4-dimensions, or any number of dimensions. In some cases, the input image may comprise 1 pixel in a dimension, at least about 2 pixels in a dimension, at least about 3 pixels in a dimension, at least about 4 pixels in a dimension, at least about 5 pixels in a dimension, at least about 6 pixels in a dimension, at least about 7 pixels in a dimension, at least about 8 pixels in a dimension, at least about 9 pixels in a dimension, at least about 10 pixels in a dimension, at least about 20 pixels in a dimension, at least about 30 pixels in a dimension, at least about 40 pixels in a dimension, at least about 50 pixels in a dimension, at least about 60 pixels in a dimension, at least about 70 pixels in a dimension, at least about 80 pixels in a dimension, at least about 90 pixels in a dimension, at least about 100 pixels in a dimension, at least about 200 pixels in a dimension, at least about 300 pixels in a dimension, at least about 400 pixels in a dimension, at least about 500 pixels in a dimension, at least about 600 pixels in a dimension, at least about 700 pixels in a dimension, at least about 800 pixels in a dimension, at least about 900 pixels in a dimension, at least about 1000 pixels in a dimension, at least about 2000 pixels in a dimension, at least about 3000 pixels in a dimension, at least about 4000 pixels in a dimension, at least about 5000 pixels in a dimension, at least about 6000 pixels in a dimension, at least about 7000 pixels in a dimension, at least about 8000 pixels in a dimension, at least about 9000 pixels in a dimension, at least about 10000 pixels in a dimension, at least about 20000 pixels in a dimension, at least about 30000 pixels in a dimension, at least about 40000 pixels in a dimension, at least about 50000 pixels in a dimension, at least about 60000 pixels in a dimension, at least about 70000 pixels in a dimension, at least about 80000 pixels in a dimension, at least about 90000 pixels in a dimension, at least about 100000 pixels in a dimension, at least about 200000 pixels in a dimension, at least about 300000 pixels in a dimension, at least about 400000 pixels in a dimension, at least about 500000 pixels in a dimension, at least about 600000 pixels in a dimension, at least about 700000 pixels in a dimension, at least about 800000 pixels in a dimension, at least about 900000 pixels in a dimension, or at least about 1000000 pixels in a dimension, including increments therein.

Various embodiments of an input image may comprise any native resolution without departing from the concepts disclosed herein. In some cases, a resolution of an annotatable object in an image is at least 1 pixel. In some cases, a resolution of an annotatable object in an image is at least about 2 pixels. In some cases, a resolution of an annotatable object in an image is at least about 3 pixels. In some cases, a resolution of an annotatable object in an image is at least about 4 pixels. In some cases, a resolution of an annotatable object in an image is at least about 5 pixels. In some cases, a resolution of an annotatable object in an image is at least about 6 pixels. In some cases, a resolution of an annotatable object in an image is at least about 7 pixels. In some cases, a resolution of an annotatable object in an image is at least about 8 pixels. In some cases, a resolution of an annotatable object in an image is at least about 9 pixels. In some cases, a resolution of an annotatable object in an image is at least about 10 pixels. In some cases, a resolution of an annotatable object in an image is at least about 20 pixels. In some cases, a resolution of an annotatable object in an image is at least about 30 pixels. In some cases, a resolution of an annotatable object in an image is at least about 40 pixels. In some cases, a resolution of an annotatable object in an image is at least about 50 pixels. In some cases, a resolution of an annotatable object in an image is at least about 60 pixels. In some cases, a resolution of an annotatable object in an image is at least about 70 pixels. In some cases, a resolution of an annotatable object in an image is at least about 80 pixels. In some cases, a resolution of an annotatable object in an image is at least about 90 pixels. In some cases, a resolution of an annotatable object in an image is at least about 100 pixels. In some cases, a resolution of an annotatable object in an image is at least about 200 pixels. In some cases, a resolution of an annotatable object in an image is at least about 300 pixels. In some cases, a resolution of an annotatable object in an image is at least about 400 pixels. In some cases, a resolution of an annotatable object in an image is at least about 500 pixels. In some cases, a resolution of an annotatable object in an image is at least about 600 pixels. In some cases, a resolution of an annotatable object in an image is at least about 700 pixels. In some cases, a resolution of an annotatable object in an image is at least about 800 pixels. In some cases, a resolution of an annotatable object in an image is at least about 900 pixels. In some cases, a resolution of an annotatable object in an image is at least about 1000 pixels. In some cases, a resolution of an annotatable object in an image is at least about 2000 pixels. In some cases, a resolution of an annotatable object in an image is at least about 3000 pixels. In some cases, a resolution of an annotatable object in an image is at least about 4000 pixels. In some cases, a resolution of an annotatable object in an image is at least about 5000 pixels. In some cases, a resolution of an annotatable object in an image is at least about 6000 pixels. In some cases, a resolution of an annotatable object in an image is at least about 7000 pixels. In some cases, a resolution of an annotatable object in an image is at least about 8000 pixels. In some cases, a resolution of an annotatable object in an image is at least about 9000 pixels. In some cases, a resolution of an annotatable object in an image is at least about 10000 pixels. In some cases, a resolution of an annotatable object in an image is at least about 20000 pixels. In some cases, a resolution of an annotatable object in an image is at least about 30000 pixels. In some cases, a resolution of an annotatable object in an image is at least about 40000 pixels. In some cases, a resolution of an annotatable object in an image is at least about 50000 pixels. In some cases, a resolution of an annotatable object in an image is at least about 60000 pixels. In some cases, a resolution of an annotatable object in an image is at least about 70000 pixels. In some cases, a resolution of an annotatable object in an image is at least about 80000 pixels. In some cases, a resolution of an annotatable object in an image is at least about 90000 pixels. In some cases, a resolution of an annotatable object in an image is at least about 100000 pixels.

Various embodiments of a tiling module may be configured to receive any number of input images at once. In some cases, the tiling module may be configured to receive 1 input image, at least about 2 input images, at least about 3 input images, at least about 4 input images, at least about 5 input images, at least about 6 input images, at least about 7 input images, at least about 8 input images, at least about 9 input images, at least about 10 input images, at least about 20 input images, at least about 30 input images, at least about 40 input images, at least about 50 input images, at least about 60 input images, at least about 70 input images, at least about 80 input images, at least about 90 input images, at least about 100 input images, at least about 200 input images, at least about 300 input images, at least about 400 input images, at least about 500 input images, at least about 600 input images, at least about 700 input images, at least about 800 input images, at least about 900 input images, at least about 1000 input images, at least about 2000 input images, at least about 3000 input images, at least about 4000 input images, at least about 5000 input images, at least about 6000 input images, at least about 7000 input images, at least about 8000 input images, at least about 9000 input images, at least about 10000 input images, at least about 20000 input images, at least about 30000 input images, at least about 40000 input images, at least about 50000 input images, at least about 60000 input images, at least about 70000 input images, at least about 80000 input images, at least about 90000 input images, at least about 100000 input images, at least about 200000 input images, at least about 300000 input images, at least about 400000 input images, at least about 500000 input images, at least about 600000 input images, at least about 700000 input images, at least about 800000 input images, at least about 900000 input images, or at least about 1000000 input images, including increments therein.

Various embodiments of a set of tile images may comprise any size without departing from the concepts disclosed herein. In some cases, a tile image in a set of tile images may comprise 1-dimension, 2-dimensions, 3-dimensions, 4-dimensions, or any number of dimensions. In some cases, a tile image in a set of tile images may comprise 1 pixel in a dimension, at least about 2 pixels in a dimension, at least about 3 pixels in a dimension, at least about 4 pixels in a dimension, at least about 5 pixels in a dimension, at least about 6 pixels in a dimension, at least about 7 pixels in a dimension, at least about 8 pixels in a dimension, at least about 9 pixels in a dimension, at least about 10 pixels in a dimension, at least about 20 pixels in a dimension, at least about 30 pixels in a dimension, at least about 40 pixels in a dimension, at least about 50 pixels in a dimension, at least about 60 pixels in a dimension, at least about 70 pixels in a dimension, at least about 80 pixels in a dimension, at least about 90 pixels in a dimension, at least about 100 pixels in a dimension, at least about 200 pixels in a dimension, at least about 300 pixels in a dimension, at least about 400 pixels in a dimension, at least about 500 pixels in a dimension, at least about 600 pixels in a dimension, at least about 700 pixels in a dimension, at least about 800 pixels in a dimension, at least about 900 pixels in a dimension, at least about 1000 pixels in a dimension, at least about 2000 pixels in a dimension, at least about 3000 pixels in a dimension, at least about 4000 pixels in a dimension, at least about 5000 pixels in a dimension, at least about 6000 pixels in a dimension, at least about 7000 pixels in a dimension, at least about 8000 pixels in a dimension, at least about 9000 pixels in a dimension, at least about 10000 pixels in a dimension, at least about 20000 pixels in a dimension, at least about 30000 pixels in a dimension, at least about 40000 pixels in a dimension, at least about 50000 pixels in a dimension, at least about 60000 pixels in a dimension, at least about 70000 pixels in a dimension, at least about 80000 pixels in a dimension, at least about 90000 pixels in a dimension, at least about 100000 pixels in a dimension, at least about 200000 pixels in a dimension, at least about 300000 pixels in a dimension, at least about 400000 pixels in a dimension, at least about 500000 pixels in a dimension, at least about 600000 pixels in a dimension, at least about 700000 pixels in a dimension, at least about 800000 pixels in a dimension, at least about 900000 pixels in a dimension, or at least about 1000000 pixels in a dimension, including increments therein.

Various embodiments of a set of tile images may comprise any number of tile images without departing from the concepts disclosed herein. In some cases, a set of tile images may comprise one image, at least about 2 images, at least about 3 images, at least about 4 images, at least about 5 images, at least about 6 images, at least about 7 images, at least about 8 images, at least about 9 images, at least about 10 images, at least about 20 images, at least about 30 images, at least about 40 images, at least about 50 images, at least about 60 images, at least about 70 images, at least about 80 images, at least about 90 images, at least about 100 images, at least about 200 images, at least about 300 images, at least about 400 images, at least about 500 images, at least about 600 images, at least about 700 images, at least about 800 images, at least about 900 images, at least about 1000 images, at least about 2000 images, at least about 3000 images, at least about 4000 images, at least about 5000 images, at least about 6000 images, at least about 7000 images, at least about 8000 images, at least about 9000 images, at least about 10000 images, at least about 20000 images, at least about 30000 images, at least about 40000 images, at least about 50000 images, at least about 60000 images, at least about 70000 images, at least about 80000 images, at least about 90000 images, at least about 100000 images, at least about 200000 images, at least about 300000 images, at least about 400000 images, at least about 500000 images, at least about 600000 images, at least about 700000 images, at least about 800000 images, at least about 900000 images, or at least about 1000000 images, including increments therein.

Various embodiments of tiling instructions or an encoding thereof may comprise a variety of information and detail without departing from the concepts disclosed herein, so long as it effectively communicates how an input image was tiled. In some cases, the tiling instructions or an encoding thereof may comprise a set of instructions used to tile an input image. In some cases, the tiling instructions or an encoding thereof may comprise one or more integers for each tile image that specify an original location in an input image from which the tile image was derived.

Various embodiments of a neural network may comprise a variety of architectures, loss functions, and the neural network may be trained using a variety of techniques without departing from the concepts disclosed herein. In some cases, a neural network may comprise an autoencoder. In some cases, a neural network may comprise a generative model. In some cases, a neural network may comprise a variational autoencoder. In some cases, a neural network may comprise a generative adversarial network. In some cases, a neural network may comprise a flow model. In some cases, a neural network may comprise an autoregressive model. In some cases, a neural network model may comprise one or more layers. In some cases, a neural network may comprise one or more fully connected layers. In some cases, a neural network may comprise one or more convolutional layers. In some cases, a neural network may comprise one or more message-passing layers. In some cases, a neural network may comprise a bottleneck layer. In some cases, a neural network may comprise residual blocks. In some cases, a neural network may comprise attention layers. In some cases, a neural network may comprise one or more non-linearities. In some cases, a neural network may comprise one or more dropout layers. In some cases, a neural network may comprise one or more batch normalization layers. In some cases, a neural network may comprise a regression loss function. In some cases, a neural network may comprise a logistic loss function. In some cases, a neural network may comprise a variational loss function. In some cases, a neural network model may comprise a prior. In some cases, a neural network may comprise a Gaussian prior. In some cases, a neural network may comprise a non-Gaussian prior. In some cases, a neural network may comprise an adversarial loss. In some cases, a neural network may comprise an autoencoding loss. In some cases, a neural network is trained with the Adam optimizer. In some cases, a neural network is trained with the stochastic gradient descent optimizer. In some cases, a neural network hyperparameters are optimized with Gaussian Processes. In some cases, a neural network may be trained with early stopping. In some cases, a neural network may be trained to minimize overfitting.

Various embodiments of one or more labels of each labeled tile image in a set of labeled tile images may comprise any number of labels, and the labels may be distributed between any number of objects in a tile image, and each label may comprise a variety of types of labels, without departing from the concepts disclosed herein. In some cases, a labeled tile image may have at least about 1 label, at least about 2 labels, at least about 3 labels, at least about 4 labels, at least about 5 labels, at least about 6 labels, at least about 7 labels, at least about 8 labels, at least about 9 labels, at least about 10 labels, at least about 20 labels, at least about 30 labels, at least about 40 labels, at least about 50 labels, at least about 60 labels, at least about 70 labels, at least about 80 labels, at least about 90 labels, at least about 100 labels, at least about 200 labels, at least about 300 labels, at least about 400 labels, at least about 500 labels, at least about 600 labels, at least about 700 labels, at least about 800 labels, at least about 900 labels, at least about 1000 labels, at least about 2000 labels, at least about 3000 labels, at least about 4000 labels, at least about 5000 labels, at least about 6000 labels, at least about 7000 labels, at least about 8000 labels, at least about 9000 labels, or at least about 10000 labels, including increments therein. The labels may be distributed between 1 object, 2 objects, 3 objects, 4 objects, 5 objects, 6 objects, 7 objects, 8 objects, 9 objects, 10 objects, 20 objects, 30 objects, 40 objects, 50 objects, 60 objects, 70 objects, 80 objects, 90 objects, 100 objects, 200 objects, 300 objects, 400 objects, 500 objects, 600 objects, 700 objects, 800 objects, 900 objects, 1000 objects, 2000 objects, 3000 objects, 4000 objects, 5000 objects, 6000 objects, 7000 objects, 8000 objects, 9000 objects, or 10000 objects, including increments therein. A label may be a true/false label, a logical label, a classification label, a categorical label, a probabilistic label, a regression label, a bounding box, an image segmentation label, a label annotation, a per-pixel classification label or any combination thereof.

Various embodiments of a label may comprise a variety of shapes and sizes without departing from the inventive concepts provided herein. In some cases, a size of a label may comprise 1 pixel, at least about 2 pixels, at least about 3 pixels, at least about 4 pixels, at least about 5 pixels, at least about 6 pixels, at least about 7 pixels, at least about 8 pixels, at least about 9 pixels, at least about 10 pixels, at least about 20 pixels, at least about 30 pixels, at least about 40 pixels, at least about 50 pixels, at least about 60 pixels, at least about 70 pixels, at least about 80 pixels, at least about 90 pixels, at least about 100 pixels, at least about 200 pixels, at least about 300 pixels, at least about 400 pixels, at least about 500 pixels, at least about 600 pixels, at least about 700 pixels, at least about 800 pixels, at least about 900 pixels, at least about 1000 pixels, at least about 2000 pixels, at least about 3000 pixels, at least about 4000 pixels, at least about 5000 pixels, at least about 6000 pixels, at least about 7000 pixels, at least about 8000 pixels, at least about 9000 pixels, or at least about 10000 pixels, including increments therein. In some cases, a shape of a label may be circular, triangular, rectangular, square, or any polygonal shape. In some cases, a shape of a label may be amorphous. In some cases, a shape of a label may match a shape of an object. In some cases, a label may be larger than an object. In some cases, a label may be smaller than an object.

Various embodiments of a complete label may comprise any label that is associated with an object that is fully bounded within a labeled image. In some cases, a complete label is bounded within a labeled tile image. In some cases, a complete label is bounded within a labeled, merged image.

Various embodiments of a partial label may comprise any label that is associated with an object that is not fully bounded within a labeled image. In some cases, a partial label is not fully bounded within a labeled tile image. In some cases, a partial label is not fully bounded within a labeled, merged image.

Various embodiments of a merged image may comprise any native size without departing from the concepts disclosed herein. In some cases, the merged image may comprise 1-dimension, 2-dimensions, 3-dimensions, 4-dimensions, or any number of dimensions. In some cases, the merged image may comprise 1 pixel in a dimension, at least about 2 pixels in a dimension, at least about 3 pixels in a dimension, at least about 4 pixels in a dimension, at least about 5 pixels in a dimension, at least about 6 pixels in a dimension, at least about 7 pixels in a dimension, at least about 8 pixels in a dimension, at least about 9 pixels in a dimension, at least about 10 pixels in a dimension, at least about 20 pixels in a dimension, at least about 30 pixels in a dimension, at least about 40 pixels in a dimension, at least about 50 pixels in a dimension, at least about 60 pixels in a dimension, at least about 70 pixels in a dimension, at least about 80 pixels in a dimension, at least about 90 pixels in a dimension, at least about 100 pixels in a dimension, at least about 200 pixels in a dimension, at least about 300 pixels in a dimension, at least about 400 pixels in a dimension, at least about 500 pixels in a dimension, at least about 600 pixels in a dimension, at least about 700 pixels in a dimension, at least about 800 pixels in a dimension, at least about 900 pixels in a dimension, at least about 1000 pixels in a dimension, at least about 2000 pixels in a dimension, at least about 3000 pixels in a dimension, at least about 4000 pixels in a dimension, at least about 5000 pixels in a dimension, at least about 6000 pixels in a dimension, at least about 7000 pixels in a dimension, at least about 8000 pixels in a dimension, at least about 9000 pixels in a dimension, at least about 10000 pixels in a dimension, at least about 20000 pixels in a dimension, at least about 30000 pixels in a dimension, at least about 40000 pixels in a dimension, at least about 50000 pixels in a dimension, at least about 60000 pixels in a dimension, at least about 70000 pixels in a dimension, at least about 80000 pixels in a dimension, at least about 90000 pixels in a dimension, at least about 100000 pixels in a dimension, at least about 200000 pixels in a dimension, at least about 300000 pixels in a dimension, at least about 400000 pixels in a dimension, at least about 500000 pixels in a dimension, at least about 600000 pixels in a dimension, at least about 700000 pixels in a dimension, at least about 800000 pixels in a dimension, at least about 900000 pixels in a dimension, or at least about 1000000 pixels in a dimension, including increments therein.

Various embodiments of a merged image may comprise any native resolution without departing from the concepts disclosed herein. In some cases, a resolution of an annotatable object in an image is at least 1 pixel. In some cases, a resolution of an annotatable object in an image is at least about 2 pixels. In some cases, a resolution of an annotatable object in an image is at least about 3 pixels. In some cases, a resolution of an annotatable object in an image is at least about 4 pixels. In some cases, a resolution of an annotatable object in an image is at least about 5 pixels. In some cases, a resolution of an annotatable object in an image is at least about 6 pixels. In some cases, a resolution of an annotatable object in an image is at least about 7 pixels. In some cases, a resolution of an annotatable object in an image is at least about 8 pixels. In some cases, a resolution of an annotatable object in an image is at least about 9 pixels. In some cases, a resolution of an annotatable object in an image is at least about 10 pixels. In some cases, a resolution of an annotatable object in an image is at least about 20 pixels. In some cases, a resolution of an annotatable object in an image is at least about 30 pixels. In some cases, a resolution of an annotatable object in an image is at least about 40 pixels. In some cases, a resolution of an annotatable object in an image is at least about 50 pixels. In some cases, a resolution of an annotatable object in an image is at least about 60 pixels. In some cases, a resolution of an annotatable object in an image is at least about 70 pixels. In some cases, a resolution of an annotatable object in an image is at least about 80 pixels. In some cases, a resolution of an annotatable object in an image is at least about 90 pixels. In some cases, a resolution of an annotatable object in an image is at least about 100 pixels. In some cases, a resolution of an annotatable object in an image is at least about 200 pixels. In some cases, a resolution of an annotatable object in an image is at least about 300 pixels. In some cases, a resolution of an annotatable object in an image is at least about 400 pixels. In some cases, a resolution of an annotatable object in an image is at least about 500 pixels. In some cases, a resolution of an annotatable object in an image is at least about 600 pixels. In some cases, a resolution of an annotatable object in an image is at least about 700 pixels. In some cases, a resolution of an annotatable object in an image is at least about 800 pixels. In some cases, a resolution of an annotatable object in an image is at least about 900 pixels. In some cases, a resolution of an annotatable object in an image is at least about 1000 pixels. In some cases, a resolution of an annotatable object in an image is at least about 2000 pixels. In some cases, a resolution of an annotatable object in an image is at least about 3000 pixels. In some cases, a resolution of an annotatable object in an image is at least about 4000 pixels. In some cases, a resolution of an annotatable object in an image is at least about 5000 pixels. In some cases, a resolution of an annotatable object in an image is at least about 6000 pixels. In some cases, a resolution of an annotatable object in an image is at least about 7000 pixels. In some cases, a resolution of an annotatable object in an image is at least about 8000 pixels. In some cases, a resolution of an annotatable object in an image is at least about 9000 pixels. In some cases, a resolution of an annotatable object in an image is at least about 10000 pixels. In some cases, a resolution of an annotatable object in an image is at least about 20000 pixels. In some cases, a resolution of an annotatable object in an image is at least about 30000 pixels. In some cases, a resolution of an annotatable object in an image is at least about 40000 pixels. In some cases, a resolution of an annotatable object in an image is at least about 50000 pixels. In some cases, a resolution of an annotatable object in an image is at least about 60000 pixels. In some cases, a resolution of an annotatable object in an image is at least about 70000 pixels. In some cases, a resolution of an annotatable object in an image is at least about 80000 pixels. In some cases, a resolution of an annotatable object in an image is at least about 90000 pixels. In some cases, a resolution of an annotatable object in an image is at least about 100000 pixels.

Various embodiments of a merging module may be configured to output any number of merged images at once. In some cases, the merging module may be configured to output 1 merged image, at least about 2 merged images, at least about 3 merged images, at least about 4 merged images, at least about 5 merged images, at least about 6 merged images, at least about 7 merged images, at least about 8 merged images, at least about 9 merged images, at least about 10 merged images, at least about 20 merged images, at least about 30 merged images, at least about 40 merged images, at least about 50 merged images, at least about 60 merged images, at least about 70 merged images, at least about 80 merged images, at least about 90 merged images, at least about 100 merged images, at least about 200 merged images, at least about 300 merged images, at least about 400 merged images, at least about 500 merged images, at least about 600 merged images, at least about 700 merged images, at least about 800 merged images, at least about 900 merged images, at least about 1000 merged images, at least about 2000 merged images, at least about 3000 merged images, at least about 4000 merged images, at least about 5000 merged images, at least about 6000 merged images, at least about 7000 merged images, at least about 8000 merged images, at least about 9000 merged images, at least about 10000 merged images, at least about 20000 merged images, at least about 30000 merged images, at least about 40000 merged images, at least about 50000 merged images, at least about 60000 merged images, at least about 70000 merged images, at least about 80000 merged images, at least about 90000 merged images, at least about 100000 merged images, at least about 200000 merged images, at least about 300000 merged images, at least about 400000 merged images, at least about 500000 merged images, at least about 600000 merged images, at least about 700000 merged images, at least about 800000 merged images, at least about 900000 merged images, or at least about 1000000 merged images, including increments therein.

Various embodiments of a neural network may comprise using any given set of various hyperparameters without departing from the inventive concepts provided herein. In some cases, hyperparameter optimization may be used. Those skilled in the art will recognize that a hyperparameter is any parameter relevant to the performance of a neural network that is not learned by the neural network. In some cases, a set of hyperparameters may comprise a learning rate, number of neural network layers, number of neural network units in a layer, non-linearities, noise controlling layers, noise inducing layers, or a variety of loss functions.

### Certain Definitions

Unless otherwise defined, all technical terms used herein have the same meaning as commonly understood by one of ordinary skill in the art to which the present subject matter belongs.

As used in this specification and the appended claims, the singular forms “a,” “an,” and “the” include plural references unless the context clearly dictates otherwise. Any reference to “or” herein is intended to encompass “and/or” unless otherwise stated.

Reference throughout this specification to “some embodiments,” “further embodiments,” or “a particular embodiment,” means that a particular feature, structure, or characteristic described in connection with the embodiment is included in at least one embodiment. Thus, the appearances of the phrase “in some embodiments,” or “in further embodiments,” or “in a particular embodiment” in various places throughout this specification are not necessarily all referring to the same embodiment. Furthermore, the particular features, structures, or characteristics may be combined in any suitable manner in one or more embodiments.

### Model Training and Inference Pipeline

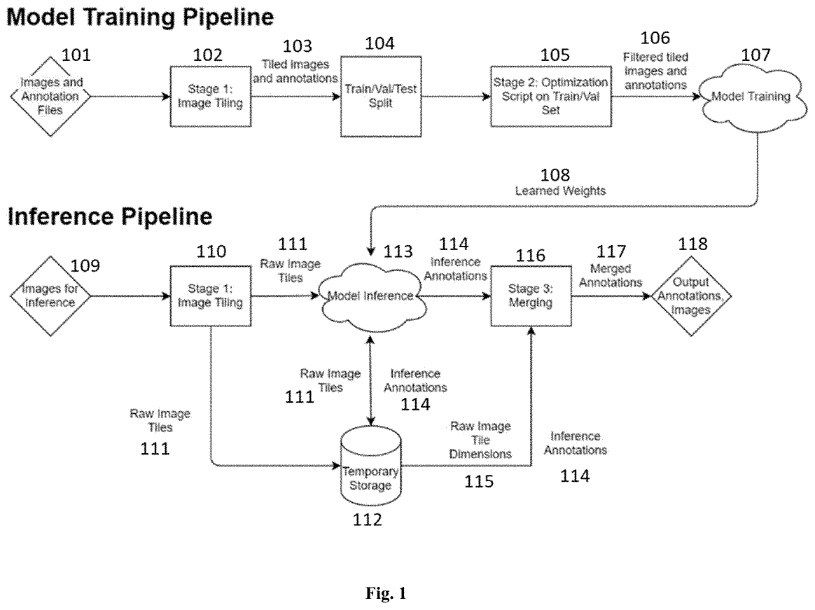

In some embodiments of the methods disclosed herein, a neural network is trained and used for inference. Referring to FIG. 1, in a particular embodiment, in Stage 1 (102), training data comprising images and annotation files (101) are processed to generate tiled images and annotations (103). The generated tile images and annotations are split into a training set, a validation set, and a test set (104). In Stage 2 (105), the training set, the validation set, and the test set are filtered to remove images that do not comprise a label to produce filtered tiled images and annotations (106). The training set is used to compute the gradients of a neural network during training (107) and to update the neural network's weights (108). The validation set is used to compute quantities (e.g., validation loss function) which can be analyzed for signs of neural network overfitting. The validation set can also be used for early stopping during training. The test set is used to compute quantities (e.g., test loss function or test accuracy) which can be used to analyze the performance of the neural network once trained given a set of hyperparameters. The neural network is trained to optimally fit to the training set while controlling for overfitting using the validation set. Once the model is fully trained, the test set is used to output model performance metrics.

Continuing to refer to FIG. 1, inference data comprising images (109) are processed by the image tiling stage (110) to generate tiled images (111). The generated tiled images (111) are stored on a temporary storage (112) and are input to the neural network (113). The neural network (113) outputs inference annotations (114), which are sent to the temporary storage device (112) and Stage 3 (116) for merging. In Stage 3 (116), data comprising raw image tile dimensions (115) and inference annotations (114) are merged to output merged annotations (117) and annotated images (118).

### Image Tiling

In some embodiments of the methods disclosed herein, input images are tiled. Tiling is the process of dividing an input image into sub-images. This subdivision of the input image may be specified to be performed according to the pixel resolution of the underlying machine learning object detection and classification model, or according to a specified number of tiles, or according to another system. For example, when working with synthetic aperture sonar (SAS) imagery with variable image sizes as a function of sensor/target distance variations, the underlying machine learning and classification model may use 640×640 pixels, and so this tile size may be applied to an input image. Alternatively, which may apply when images in a given image processing system use a standard resolution (such as the UHD standard of 3840×2160 pixels), the pipeline may be standardized on a fixed number of tiles, with the tile size being determined by dividing the native resolution of an input image into that fixed number of tiles while maintaining the ratio of the original image.

In some cases, the methods disclosed herein may incorporate an approach for tiling fixed-pixel-sized tiles to capture the edges of each image and to prevent image loss (201) in the case of inadequate pixel division. This process increases the total size of the image to the minimum multiple of the tile size required to tile the entire image, and padding (202) is added to fill any void created between the original image size and the tiled area. In some cases, padding is an area filled with black pixels.

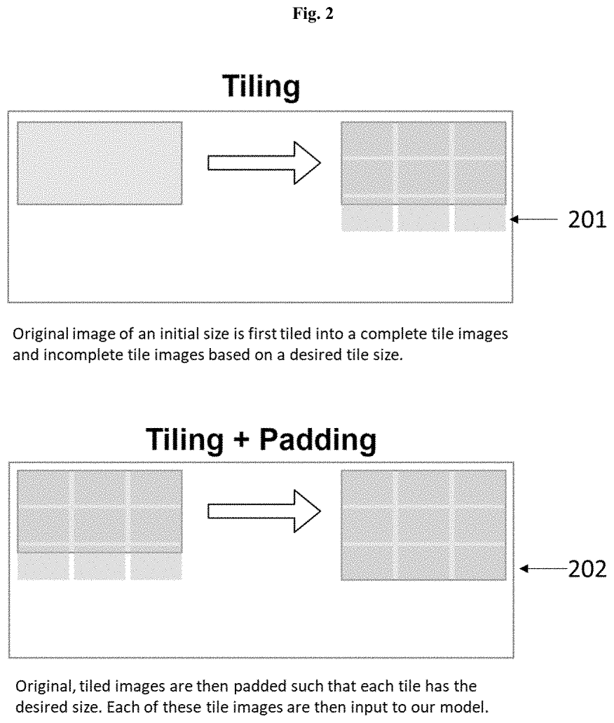

Referring to FIG. 2, in a particular embodiment, a native resolution image having a particular size is the input image. To tile this image into even fixed sized tiles for object detection using the YOLOv5 object detection algorithm, a tiling algorithm partitions (e.g., plots) the native resolution image in a grid so that it can output a set of even tiles. The algorithm, in this embodiment, adds padding to the native resolution image so that every tile has the same size.

By way of non-limiting example, a native resolution image with a size of 6752×1544 (width by height in pixels). Is optionally tiled into even 640×640 pixel fixed sized tiles for object detection using the YOLOv5 object detection algorithm. In this example, the algorithm partitions (e.g., plots) the native resolution image in a 7040×1920 pixel grid so that it can output 33 even tiles of 640×640 pixels.

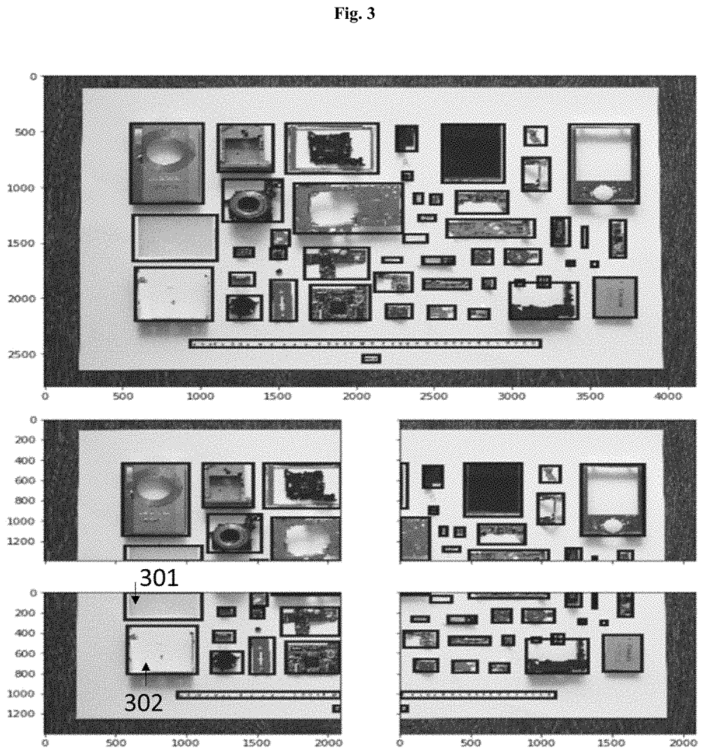

Referring to FIG. 3, in a particular embodiment, upon tiling, the edge tiles contain partial data from the image (e.g., portions of an object or portions of an annotation), plus empty space which is filled with padding. For labeled objects within the image that were cut by the tiling process (301), the bounding box difference on either side of the tile line is calculated as a function of the edge of the tile from which it was sliced, resulting in partial labels among tiles. Upon tiling, complete labels (302) may result for some objects.

In some cases, the methods disclosed herein may comprise storing the tiling instructions or an encoding thereof on a storage device. In some cases, the tiling method creates a mapping file using a unique naming scheme pertaining to the original image and tiling method, which is saved to a temporary storage tree along with the resulting image files and annotation or labeling data.

In some cases, the methods disclosed herein may comprise a data optimization step. This optimization occurs after all images and annotations are tiled and sorted for model training, at which time the dataset is scanned by an optimization script that removes tiles without any labels or bounding boxes from the training data set. This optimizes both training speed and detection performance of our method. For our dataset of 102, 192 total images (204, 384 total files including labeling data) were reduced to 19,624 labeled training images, which resulted in a simultaneous training time decrease of 9.76× per epoch and 11.37× mean average precision performance boost. This processing pipeline optimization can bring similar computational and object detection/classification accuracy benefits to datasets where significant numbers of the tiles of a significant portion of a dataset's images do not contain labeled objects. This optimization may particularly beneficial in the processing of images which contain significant proportions of unlabeled areas, such as SAS imagery where the model is being trained to search for infrequently encountered, small elements.

### Image Merging

In some cases, the methods disclosed herein may comprise taking images and labels output from neural network inference and restoring them to the native input image size and resolution. Images and labels output from inference are saved into a temporary storage tree in such a way that they can be matched using the tiling instructions or an encoding thereof. The images and labels output from inference may be fed into a merging loop for each input image and corresponding tiles.

The merging loop may first extract the image sizes from the tiles and native image and uses this data to calculate the tile dimensions for the ordering of the tiles. The critical variables for this process are the tile height and width (th, tw), original image height and width (oh, ow), padded size height and width (ph, pw).

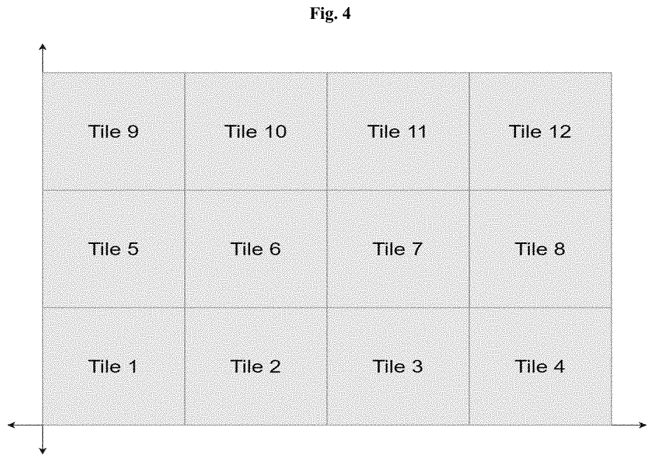

Using these variables, both tiles and images are converted to their matrix formats, e.g., 3D matrix of dimensions (width×height×depth), with the depth channel referring to the color channel of the image, and are “plotted” from bottom up on a zero matrix the size of the padded size. A non-limiting example of this method is illustrated in FIG. 4.

Mathematically, this can be expressed in block notation where the merged image matrix is an augmented matrix of “tile matrices” formally as:

$$I = ( {T}_{1} \vert {T}_{2} \vert {T}_{n} ) = ( \begin{matrix}\begin{matrix}{t}_{1 , 1} \\ {t}_{1 , 3}\end{matrix} & \begin{matrix}{t}_{1 , 2} \\ {t}_{1 , 4}\end{matrix} \vert \begin{matrix}{t}_{2 , 1} \\ {t}_{2 , 3}\end{matrix} & \begin{matrix}{t}_{2 , 2} \\ {t}_{2 , 4}\end{matrix} \vert \begin{matrix}{t}_{n , 1} \\ {t}_{n , 3}\end{matrix} & \begin{matrix}{t}_{n , 2} \\ {t}_{n , 4}\end{matrix}\end{matrix} )$$

Following the tile concatenation, the merged image is cropped to its native dimensions, removing all the padded black pixels added in stage 1.

In this exemplary implementation, the image merge is computed to get the annotation tile merging order, but the resulting full-scale images were not saved to the storage tree to reduce memory and speed, although the user or process may save this data if desired.

For merging, the system may determine the correct tile merging order, depending on the deep learning library used. In particular, it may invert the top-to-bottom order of the output tiles in order to account for the fact that libraries such as a Python library are based on an inverted y axis and may therefore require the pipeline to invert the y coordinates upon reassembly. Mathematically, it is a simple task of elementary row operations where the image matrix is left-multiplied by an augmented identity matrix with rows 1 and 3 swapped (Assume I to be the image matrix from above, not the identity matrix):

$$[ \begin{matrix}0 & 0 & 1 \\ 0 & 1 & 0 \\ 1 & 0 & 0\end{matrix} ] \times I$$

The annotation files are parsed, and labels and bounding box coordinates may be calculated according to the same process.

In an exemplary implementation the following variables are used: Tile height and width; (tw, th)=(640, 640). Original image size; (ow, oh)=(6752, 1544). Padded size; (pw, ph)=(7040, 1920). This results in ordered tile positions of the form [(0, 640), (0, 1280), (0, 1920), (640, 0), (640, 640), (640, 1280), . . . ] for each tile and uses as the th* and tw* for the transformation calculation.

The bounding box coordinates on the tiles are then normalized with respect to the native resolution through a transformation matrix which applies for each bounding box:

[xₘᵢₙ+t_{w}*,yₘᵢₙ+tₕ*,xₘₐₓ+t_{w}*,yₘₐₓ+tₕ*]

In order to ensure consistent object detection and classification across merged tiles, the resulting normalized bounding box and class label are then checked with an overlap algorithm. The overlap algorithm will look for instances where bounding boxes overlap on a single class, and effectively “fuse” the overlaps. Fusing may comprise fusing a label, such as a bounding box, an annotation, a classification label, any other label, or any combination thereof. This combination takes the respective minimum and maximum pixel values between all overlaps with regards to the merged image file. Explicitly, an overlap may be defined between two bounding boxes: a and b when all the following conditions are satisfied:

xₘᵢₙ^{a}≤xₘₐₓ^{b} I.

xₘₐₓ^{a}≥xₘᵢₙ^{b} II.

yₘᵢₙ^{a}≤yₘₐₓ^{b} III.

yₘₐₓ^{a}≥yₘᵢₙ^{b} IV.

If an overlap is found, the resulting bounding box is defined as:

[min{xₘᵢₙ^{a},xₘᵢₙ^{b}},min{yₘᵢₙ^{a},yₘᵢₙ^{b}},max{xₘₐₓ^{a},xₘₐₓ^{b}},max{yₘₐₓ^{a},yₘₐₓ^{b}}]

The normalized coordinates for all class labels are then concatenated, and the final annotation file is output.

In some cases, an overlap may be defined when two partial labels each from individual tiles share one or more labels, and a pixel of one partial label is adjacent to a pixel of another partial label. In some cases, a partial label may be a classification label. In some cases, sharing one or more labels may be defined as the most probable classification being the same for the two partial labels.

The bounding box/pixel map and class label annotations are overlaid with the original image as inference results. This output may be provided directly to an operator via a user interface, interface, or API, or may first be stored or recorded before being otherwise processed or used. The image may be merged with the label and pixel coordinate maps, or these may be kept separate or integrated with other data or representations.

### Computing System

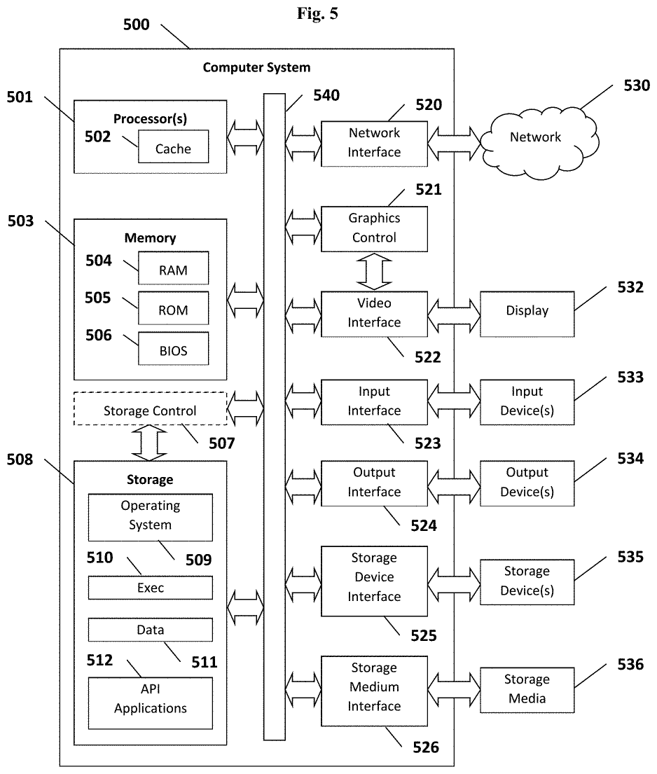

Referring to FIG. 5, a block diagram is shown depicting an exemplary machine that includes a computer system 500 (e.g., a processing or computing system) within which a set of instructions can execute for causing a device to perform or execute any one or more of the aspects and/or methodologies for static code scheduling of the present disclosure. The components in FIG. 5 are examples only and do not limit the scope of use or functionality of any hardware, software, embedded logic component, or a combination of two or more such components implementing particular embodiments.

Computer system 500 may include one or more processors 501, a memory 503, and a storage 508 that communicate with each other, and with other components, via a bus 540. The bus 540 may also link a display 532, one or more input devices 533 (which may, for example, include a keypad, a keyboard, a mouse, a stylus, etc.), one or more output devices 534, one or more storage devices 535, and various tangible storage media 536. All of these elements may interface directly or via one or more interfaces or adaptors to the bus 540. For instance, the various tangible storage media 536 can interface with the bus 540 via storage medium interface 526. Computer system 500 may have any suitable physical form, including but not limited to one or more integrated circuits (ICs), printed circuit boards (PCBs), mobile handheld devices (such as mobile telephones or PDAs), laptop or notebook computers, distributed computer systems, computing grids, or servers.

Computer system 500 includes one or more processor(s) 501 (e.g., central processing units (CPUs), general purpose graphics processing units (GPGPUs), or quantum processing units (QPUs)) that carry out functions. Processor(s) 501 optionally contains a cache memory unit 502 for temporary local storage of instructions, data, or computer addresses. Processor(s) 501 are configured to assist in execution of computer readable instructions. Computer system 500 may provide functionality for the components depicted in FIG. 5 as a result of the processor(s) 501 executing non-transitory, processor-executable instructions embodied in one or more tangible computer-readable storage media, such as memory 503, storage 508, storage devices 535, and/or storage medium 536. The computer-readable media may store software that implements particular embodiments, and processor(s) 501 may execute the software. Memory 503 may read the software from one or more other computer-readable media (such as mass storage device(s) 535, 536) or from one or more other sources through a suitable interface, such as network interface 520. The software may cause processor(s) 501 to carry out one or more processes or one or more steps of one or more processes described or illustrated herein. Carrying out such processes or steps may include defining data structures stored in memory 503 and modifying the data structures as directed by the software.

The memory 503 may include various components (e.g., machine readable media) including, but not limited to, a random access memory component (e.g., RAM 504) (e.g., static RAM (SRAM), dynamic RAM (DRAM), ferroelectric random access memory (FRAM), phase-change random access memory (PRAM), etc.), a read-only memory component (e.g., ROM 505), and any combinations thereof. ROM 505 may act to communicate data and instructions unidirectionally to processor(s) 501, and RAM 504 may act to communicate data and instructions bidirectionally with processor(s) 501. ROM 505 and RAM 504 may include any suitable tangible computer-readable media described below. In one example, a basic input/output system 506 (BIOS), including basic routines that help to transfer information between elements within computer system 500, such as during start-up, may be stored in the memory 503.

Fixed storage 508 is connected bidirectionally to processor(s) 501, optionally through storage control unit 507. Fixed storage 508 provides additional data storage capacity and may also include any suitable tangible computer-readable media described herein. Storage 508 may be used to store operating system 509, executable(s) 510, data 511, applications 512 (application programs), and the like. Storage 508 can also include an optical disk drive, a solid-state memory device (e.g., flash-based systems), or a combination of any of the above. Information in storage 508 may, in appropriate cases, be incorporated as virtual memory in memory 503.

In one example, storage device(s) 535 may be removably interfaced with computer system 500 (e.g., via an external port connector (not shown)) via a storage device interface 525. Particularly, storage device(s) 535 and an associated machine-readable medium may provide non-volatile and/or volatile storage of machine-readable instructions, data structures, program modules, and/or other data for the computer system 500. In one example, software may reside, completely or partially, within a machine-readable medium on storage device(s) 535. In another example, software may reside, completely or partially, within processor(s) 501.

Bus 540 connects a wide variety of subsystems. Herein, reference to a bus may encompass one or more digital signal lines serving a common function, where appropriate. Bus 540 may be any of several types of bus structures including, but not limited to, a memory bus, a memory controller, a peripheral bus, a local bus, and any combinations thereof, using any of a variety of bus architectures. As an example and not by way of limitation, such architectures include an Industry Standard Architecture (ISA) bus, an Enhanced ISA (EISA) bus, a Micro Channel Architecture (MCA) bus, a Video Electronics Standards Association local bus (VLB), a Peripheral Component Interconnect (PCI) bus, a PCI-Express (PCI-X) bus, an Accelerated Graphics Port (AGP) bus, HyperTransport (HTX) bus, serial advanced technology attachment (SATA) bus, and any combinations thereof.

Computer system 500 may also include an input device 533. In one example, a user of computer system 500 may enter commands and/or other information into computer system 500 via input device(s) 533. Examples of an input device(s) 533 include, but are not limited to, an alpha-numeric input device (e.g., a keyboard), a pointing device (e.g., a mouse or touchpad), a touchpad, a touch screen, a multi-touch screen, a joystick, a stylus, a gamepad, an audio input device (e.g., a microphone, a voice response system, etc.), an optical scanner, a video or still image capture device (e.g., a camera), and any combinations thereof. In some embodiments, the input device is a Kinect, Leap Motion, or the like. Input device(s) 533 may be interfaced to bus 540 via any of a variety of input interfaces 523 (e.g., input interface 523) including, but not limited to, serial, parallel, game port, USB, FIREWIRE, THUNDERBOLT, or any combination of the above.

In particular embodiments, when computer system 500 is connected to network 530, computer system 500 may communicate with other devices, specifically mobile devices and enterprise systems, distributed computing systems, cloud storage systems, cloud computing systems, and the like, connected to network 530. Communications to and from computer system 500 may be sent through network interface 520. For example, network interface 520 may receive incoming communications (such as requests or responses from other devices) in the form of one or more packets (such as Internet Protocol (IP) packets) from network 530, and computer system 500 may store the incoming communications in memory 503 for processing. Computer system 500 may similarly store outgoing communications (such as requests or responses to other devices) in the form of one or more packets in memory 503 and communicated to network 530 from network interface 520. Processor(s) 501 may access these communication packets stored in memory 503 for processing.

Examples of the network interface 520 include, but are not limited to, a network interface card, a modem, and any combination thereof. Examples of a network 530 or network segment 530 include, but are not limited to, a distributed computing system, a cloud computing system, a wide area network (WAN) (e.g., the Internet, an enterprise network), a local area network (LAN) (e.g., a network associated with an office, a building, a campus or other relatively small geographic space), a telephone network, a direct connection between two computing devices, a peer-to-peer network, and any combinations thereof. A network, such as network 530, may employ a wired and/or a wireless mode of communication. In general, any network topology may be used.

Information and data can be displayed through a display 532. Examples of a display 532 include, but are not limited to, a cathode ray tube (CRT), a liquid crystal display (LCD), a thin film transistor liquid crystal display (TFT-LCD), an organic liquid crystal display (OLED) such as a passive-matrix OLED (PMOLED) or active-matrix OLED (AMOLED) display, a plasma display, and any combinations thereof. The display 532 can interface to the processor(s) 501, memory 503, and fixed storage 508, as well as other devices, such as input device(s) 533, via the bus 540. The display 532 is linked to the bus 540 via a video interface 522, and transport of data between the display 532 and the bus 540 can be controlled via the graphics control 521. In some embodiments, the display is a video projector. In some embodiments, the display is a head-mounted display (HMD) such as a VR headset. In further embodiments, suitable VR headsets include, by way of non-limiting examples, HTC Vive, Oculus Rift, Samsung Gear VR, Microsoft HoloLens, Razer OSVR, FOVE VR, Zeiss VR One, Avegant Glyph, Freefly VR headset, and the like. In still further embodiments, the display is a combination of devices such as those disclosed herein.

In addition to a display 532, computer system 500 may include one or more other peripheral output devices 534 including, but not limited to, an audio speaker, a printer, a storage device, and any combinations thereof. Such peripheral output devices may be connected to the bus 540 via an output interface 524. Examples of an output interface 524 include, but are not limited to, a serial port, a parallel connection, a USB port, a FIREWIRE port, a THUNDERBOLT port, and any combinations thereof.

In addition or as an alternative, computer system 500 may provide functionality as a result of logic hardwired or otherwise embodied in a circuit, which may operate in place of or together with software to execute one or more processes or one or more steps of one or more processes described or illustrated herein. Reference to software in this disclosure may encompass logic, and reference to logic may encompass software. Moreover, reference to a computer-readable medium may encompass a circuit (such as an IC) storing software for execution, a circuit embodying logic for execution, or both, where appropriate. The present disclosure encompasses any suitable combination of hardware, software, or both.

Those of skill in the art will appreciate that the various illustrative logical blocks, modules, circuits, and algorithm steps described in connection with the embodiments disclosed herein may be implemented as electronic hardware, computer software, or combinations of both. To clearly illustrate this interchangeability of hardware and software, various illustrative components, blocks, modules, circuits, and steps have been described above generally in terms of their functionality.

The various illustrative logical blocks, modules, and circuits described in connection with the embodiments disclosed herein may be implemented or performed with a general purpose processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general purpose processor may be a microprocessor, but in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration.

The steps of a method or algorithm described in connection with the embodiments disclosed herein may be embodied directly in hardware, in a software module executed by one or more processor(s), or in a combination of the two. A software module may reside in RAM memory, flash memory, ROM memory, EPROM memory, EEPROM memory, registers, hard disk, a removable disk, a CD-ROM, or any other form of storage medium known in the art. An exemplary storage medium is coupled to the processor such the processor can read information from, and write information to, the storage medium. In the alternative, the storage medium may be integral to the processor. The processor and the storage medium may reside in an ASIC. The ASIC may reside in a user terminal. In the alternative, the processor and the storage medium may reside as discrete components in a user terminal.

In accordance with the description herein, suitable computing devices include, by way of non-limiting examples, server computers, desktop computers, laptop computers, notebook computers, sub-notebook computers, netbook computers, netpad computers, handheld computers, Internet appliances, mobile smartphones, tablet computers, and in some cases, vehicles. Those of skill in the art will also recognize that select televisions, video players, and digital music players with optional computer network connectivity are suitable for use in the system described herein. Suitable tablet computers, in various embodiments, include those with booklet, slate, and convertible configurations, known to those of skill in the art.

In some embodiments, the computing device includes an operating system configured to perform executable instructions. The operating system is, for example, software, including programs and data, which manages the device's hardware and provides services for execution of applications. Those of skill in the art will recognize that suitable server operating systems include, by way of non-limiting examples, FreeBSD, OpenBSD, NetBSD®, Linux, Apple® Mac OS X Server®, Oracle® Solaris®, Windows Server®, and Novell® NetWare®. Those of skill in the art will recognize that suitable personal computer operating systems include, by way of non-limiting examples, Microsoft® Windows®, Apple® Mac OS X®, UNIX®, and UNIX-like operating systems such as GNU/Linux®. In some embodiments, the operating system is provided by cloud computing. Those of skill in the art will also recognize that suitable mobile smartphone operating systems include, by way of non-limiting examples, Nokia® Symbian® OS, Apple® iOS®, Research In Motion® BlackBerry OS®, Google® Android®, Microsoft® Windows Phone® OS, Microsoft® Windows Mobile® OS, Linux®, and Palm® WebOS®.

### Non-transitory Computer Readable Storage Medium

In some embodiments, the platforms, systems, media, and methods disclosed herein include one or more non-transitory computer readable storage media encoded with a program including instructions executable by the operating system of an optionally networked computing device. In further embodiments, a computer readable storage medium is a tangible component of a computing device. In still further embodiments, a computer readable storage medium is optionally removable from a computing device. In some embodiments, a computer readable storage medium includes, by way of non-limiting examples, CD-ROMs, DVDs, flash memory devices, solid state memory, magnetic disk drives, magnetic tape drives, optical disk drives, distributed computing systems including cloud computing systems and services, and the like. In some cases, the program and instructions are permanently, substantially permanently, semi-permanently, or non-transitorily encoded on the media.

### Computer Program

In some embodiments, the platforms, systems, media, and methods disclosed herein include at least one computer program, or use of the same. A computer program includes a sequence of instructions, executable by one or more processor(s) of the computing device's CPU, written to perform a specified task. Computer readable instructions may be implemented as program modules, such as functions, objects, Application Programming Interfaces (APIs), computing data structures, and the like, that perform particular tasks or implement particular abstract data types. In light of the disclosure provided herein, those of skill in the art will recognize that a computer program may be written in various versions of various languages.

The functionality of the computer readable instructions may be combined or distributed as desired in various environments. In some embodiments, a computer program comprises one sequence of instructions. In some embodiments, a computer program comprises a plurality of sequences of instructions. In some embodiments, a computer program is provided from one location. In other embodiments, a computer program is provided from a plurality of locations. In various embodiments, a computer program includes one or more software modules. In various embodiments, a computer program includes, in part or in whole, one or more web applications, one or more standalone applications, one or more web browser plug-ins, extensions, add-ins, or add-ons, or combinations thereof.

### Web Application

In some embodiments, a computer program includes a web application. In light of the disclosure provided herein, those of skill in the art will recognize that a web application, in various embodiments, utilizes one or more software frameworks and one or more database systems. In some embodiments, a web application is created upon a software framework such as Microsoft® .NET or Ruby on Rails (RoR). In some embodiments, a web application utilizes one or more database systems including, by way of non-limiting examples, relational, non-relational, object oriented, associative, XML, and document oriented database systems. In further embodiments, suitable relational database systems include, by way of non-limiting examples, Microsoft® SQL Server, mySQL™, and Oracle®. Those of skill in the art will also recognize that a web application, in various embodiments, is written in one or more versions of one or more languages. A web application may be written in one or more markup languages, presentation definition languages, client-side scripting languages, server-side coding languages, database query languages, or combinations thereof. In some embodiments, a web application is written to some extent in a markup language such as Hypertext Markup Language (HTML), Extensible Hypertext Markup Language (XHTML), or eXtensible Markup Language (XML). In some embodiments, a web application is written to some extent in a presentation definition language such as Cascading Style Sheets (CSS). In some embodiments, a web application is written to some extent in a client-side scripting language such as Asynchronous JavaScript and XML (AJAX), Flash® ActionScript, JavaScript, or Silverlight®. In some embodiments, a web application is written to some extent in a server-side coding language such as Active Server Pages (ASP), ColdFusion®, Perl, Java™, JavaServer Pages (JSP), Hypertext Preprocessor (PHP), Python™, Ruby, Tcl, Smalltalk, WebDNA®, or Groovy. In some embodiments, a web application is written to some extent in a database query language such as Structured Query Language (SQL). In some embodiments, a web application integrates enterprise server products such as IBM® Lotus Domino®.

### Mobile Application

In some embodiments, a computer program includes a mobile application provided to a mobile computing device. In some embodiments, the mobile application is provided to a mobile computing device at the time it is manufactured. In other embodiments, the mobile application is provided to a mobile computing device via the computer network described herein.

In view of the disclosure provided herein, a mobile application is created by techniques known to those of skill in the art using hardware, languages, and development environments known to the art. Those of skill in the art will recognize that mobile applications are written in several languages. Suitable programming languages include, by way of non-limiting examples, C, C++, C#, Objective-C, Java™, JavaScript, Pascal, Object Pascal, Python™, Ruby, VB.NET, WML, and XHTML/HTML with or without CSS, or combinations thereof.

Suitable mobile application development environments are available from several sources. Commercially available development environments include, by way of non-limiting examples, AirplaySDK, alcheMo, Appcelerator®, Celsius, Bedrock, Flash Lite, .NET Compact Framework, Rhomobile, and WorkLight Mobile Platform. Other development environments are available without cost including, by way of non-limiting examples, Lazarus, MobiFlex, MoSync, and Phonegap. Also, mobile device manufacturers distribute software developer kits including, by way of non-limiting examples, iPhone and iPad (iOS) SDK, Android™ SDK, BlackBerry® SDK, BREW SDK, Palm® OS SDK, Symbian SDK, webOS SDK, and Windows® Mobile SDK.

Those of skill in the art will recognize that several commercial forums are available for distribution of mobile applications including, by way of non-limiting examples, Apple® App Store, Google® Play, Chrome WebStore, BlackBerry® App World, App Store for Palm devices, App Catalog for webOS, Windows® Marketplace for Mobile, Ovi Store for Nokia® devices, and Samsung® Apps.

### Standalone Application

In some embodiments, a computer program includes a standalone application, which is a program that is run as an independent computer process, not an add-on to an existing process, e.g., not a plug-in. Those of skill in the art will recognize that standalone applications are often compiled. A compiler is a computer program(s) that transforms source code written in a programming language into binary object code such as assembly language or machine code. Suitable compiled programming languages include, by way of non-limiting examples, C, C++, Objective-C, COBOL, Delphi, Eiffel, Java™, Lisp, Python™, Visual Basic, and VB .NET, or combinations thereof. Compilation is often performed, at least in part, to create an executable program. In some embodiments, a computer program includes one or more executable complied applications.

### Software Modules

In some embodiments, the platforms, systems, media, and methods disclosed herein include software, server, and/or database modules, or use of the same. In view of the disclosure provided herein, software modules are created by techniques known to those of skill in the art using machines, software, and languages known to the art. The software modules disclosed herein are implemented in a multitude of ways. In various embodiments, a software module comprises a file, a section of code, a programming object, a programming structure, a distributed computing resource, a cloud computing resource, or combinations thereof. In further various embodiments, a software module comprises a plurality of files, a plurality of sections of code, a plurality of programming objects, a plurality of programming structures, a plurality of distributed computing resources, a plurality of cloud computing resources, or combinations thereof. In various embodiments, the one or more software modules comprise, by way of non-limiting examples, a web application, a mobile application, a standalone application, and a distributed or cloud computing application. In some embodiments, software modules are in one computer program or application. In other embodiments, software modules are in more than one computer program or application. In some embodiments, software modules are hosted on one machine. In other embodiments, software modules are hosted on more than one machine. In further embodiments, software modules are hosted on a distributed computing platform such as a cloud computing platform. In some embodiments, software modules are hosted on one or more machines in one location. In other embodiments, software modules are hosted on one or more machines in more than one location.

### Databases

In some embodiments, the platforms, systems, media, and methods disclosed herein include one or more databases, or use of the same. In view of the disclosure provided herein, those of skill in the art will recognize that many databases are suitable for storage and retrieval of information about images, tiled images, tiling instructions, encoding of tiling instructions, or any combination thereof. In various embodiments, suitable databases include, by way of non-limiting examples, relational databases, non-relational databases, object oriented databases, object databases, entity-relationship model databases, associative databases, XML databases, document oriented databases, and graph databases. Further non-limiting examples include SQL, PostgreSQL, MySQL, Oracle, DB2, Sybase, and MongoDB. In some embodiments, a database is Internet-based. In further embodiments, a database is web-based. In still further embodiments, a database is cloud computing-based. In a particular embodiment, a database is a distributed database. In other embodiments, a database is based on one or more local computer storage devices.

While preferred embodiments of the present subject matter have been shown and described herein, it will be obvious to those skilled in the art that such embodiments are provided by way of example only. Numerous variations, changes, and substitutions will now occur to those skilled in the art without departing from the present subject matter. It should be understood that various alternatives to the embodiments of the present subject matter described herein may be employed in practicing the present subject matter.

What is claimed is:

1. A computer-implemented system comprising: at least one a digital processing device comprising at least one processor and instructions executable by the at least one processor to create an image analysis application, the application comprising:
(a) a tiling module configured to receive an input image, wherein said input image comprises a native resolution and a native size, and output (i) a set of tile images and (ii) tiling instructions or an encoding thereof used to output said set of tile images, wherein each tile image in said set of tile images comprises a same tile size and said native resolution;
(b) a neural network configured to receive said set of tile images from said tiling module and output a set of labeled tile images, wherein each labeled tile image in said set of labeled tile images comprises one or more labels, wherein each label in said one or more labels is a partial label or a complete label; and
(c) a merging module configured to receive said set of labeled tile images from said neural network and said tiling instructions or encoding thereof from said tiling module and output a decoded, labeled, merged image, wherein said labeled merged image comprises said native resolution, said native size, and one or more merged labels, wherein each merged label in said one or more merged labels comprises at least one of: (i) a partial label as received from said set of labeled tile images, (ii) a complete label as received from said set of labeled tile images, or (iii) a complete label formed by merging a plurality of partial labels received from said set of labeled tile images.

2. The computer-implemented system of claim 1 comprising a training application configured to train said neural network, wherein said training application comprises a training module configured to perform at least the following:
(a) tile a set of labeled input images using said tiling module to output a set of labeled tiled input images;
(b) remove each image from said set of labeled tiled input images that do not comprise a label;
(c) provide said set of labeled tiled input images as training data to said neural network; and
(d) train said neural network.

3. The computer-implemented system of claim 1, wherein each label in said set of labeled tile images comprises at least one of: a classification label, an image segmentation label, and a label annotation.

4. The computer-implemented system of claim 3, wherein each label in said plurality of partial labels shares one or more pixels and a label annotation with at least one other label in said plurality of partial labels.

5. The computer-implemented system of claim 3, wherein said classification label is a per-pixel classification label.

6. The computer-implemented system of claim 3, wherein said image segmentation label is a bounding box.

7. The computer implemented system of claim 6, wherein said bounding box is rectangular.

8. The computer-implemented system of claim 1, wherein said tiling module is additionally configured to add padding to said input image before tiling.

9. The computer-implemented system of claim 1, wherein said input image comprises two-dimensions.

10. A non-transitory computer-readable storage media encoded with instructions executable by one or more processors to create an image analysis application comprising:
(a) a tiling module configured to receive an input image, wherein said input image comprises a native resolution and a native size, and output (i) a set of tile images and (ii) tiling instructions or an encoding thereof used to output said set of tile images, wherein each tile image in said set of tile images comprises a same tile size and said native resolution;
(b) a neural network configured to receive said set of tile images from said tiling module and output a set of labeled tile images, wherein each labeled tile image in said set of labeled tile images comprises one or more labels, wherein each label in said one or more labels is a partial label or a complete label; and
(c) a merging module configured to receive said set of labeled tile images from said neural network and said tiling instructions or encoding thereof from said tiling module and output a labeled merged image, wherein said labeled merged image comprises said native resolution, said native size, and one or more merged labels, wherein each merged label in said one or more merged labels comprises at least one of: (i) a partial label as received from said set of labeled tile images, (ii) a complete label as received from said set of labeled tile images, or (iii) a complete label formed by merging a plurality of partial labels received from said set of labeled tile images.

11. The non-transitory computer-readable storage media of claim 10 comprising a training application configured to train said neural network, wherein said training application comprises a training module configured to perform at least the following:
(a) tile a set of labeled input images using said tiling module to output a set of labeled tiled input images;
(b) remove each image from said set of labeled tiled input images that do not comprise a label;
(c) provide said set of labeled tiled input images as training data to said neural network; and
(d) train said neural network.

12. The non-transitory computer-readable storage media of claim 10, wherein each label in said set of labeled tile images comprises at least one of: a classification label, an image segmentation label, and a label annotation.

13. The non-transitory computer-readable storage media of claim 12, wherein each label in said plurality of partial labels shares one or more pixels and a label annotation with at least one other label in said plurality of partial labels.

14. The non-transitory computer-readable storage media of claim 12, wherein said classification label is a per-pixel classification label.

15. The non-transitory computer-readable storage media of claim 12, wherein said image segmentation label is a bounding box.

16. The non-transitory computer-readable storage media of claim 15, wherein said bounding box is rectangular.

17. The non-transitory computer-readable storage media of claim 10, wherein said tiling module is additionally configured to add padding to said input image before tiling.

18. The non-transitory computer-readable storage media of claim 10, wherein said input image comprises two-dimensions.

19. A computer-implemented method of creating a labeled image comprising:
(a) tiling an input image comprising a native resolution and a native size to generate (i) a set of tiled images and (ii) tiling instructions or an encoding thereof used to generate said set of tile images, wherein each tile image in said set of tile images comprises a same tile size and said native resolution;
(b) labeling said set of tiled images to generate a set of labeled tile images, wherein each tile image in said set of labeled tile images comprises one or more labels, wherein each label in said one or more labels is a partial label or a complete label; and
(c) merging said set of labeled tile images using said tiling instructions or encoding thereof to generate a labeled merged image, wherein said labeled merged image comprises said native resolution, said native size, and one or more merged labels, wherein each merged label in said one or more merged labels comprises at least one of: (i) a partial label as received from said set of labeled tile images, (ii) a complete label as received from said set of labeled tile images, or (iii) a complete label formed by merging a plurality of partial labels received from said set of labeled tile images.

20. The method of claim 19, wherein said neural network is trained with a set of labeled tiled input images as training data, wherein said set of labeled tiled input images is generated by tiling a set of labeled input images, and each image in said set of labeled tiled input images that do not comprise a label is removed from said set of labeled tiled input images.

21. The method of claim 19, wherein each label in said set of labeled tile images comprises at least one of: a classification label, an image segmentation label, and a label annotation.

22. The method of claim 21, wherein each label in said plurality of partial labels shares one or more pixels and a label annotation with at least one other label in said plurality of partial labels.

23. The method of claim 21, wherein said classification label is a per-pixel classification label.

24. The method of claim 21, wherein said image segmentation label is a bounding box.

25. The method of claim 24, wherein said bounding box is rectangular.

26. The method of claim 19, wherein said tiling comprises adding padding to said input image before tiling.

27. The method of claim 19, wherein said input image comprises two-dimensions.
